(19) United States
(12) Patent Application Publication
(10) Pub. No.: US 2021/0223885 A1
(43) Pub. Date: Jul. 22, 2021

(54) OPERATION DEVICE

(71) Applicant: KABUSHIKI KAISHA TOKAI RIKA DENKI SEISAKUSHO, Aichi (JP)

(72) Inventors: Takao IMAI, Aichi (JP); Katsuhiro TSUCHIYA, Aichi (JP)

(21) Appl. No.: 17/149,273

(22) Filed: Jan. 14, 2021

(30) Foreign Application Priority Data
Jan. 16, 2020 (JP) 2020-005096

(51) Int. Cl. G06F 3/044

(52) U.S. Cl. CPC G06F 3/044

(57) ABSTRACT

An operation device includes an operation member including a plurality of symbols on a front surface side thereof, plural detection electrodes that are aligned on a back surface side of the operation member and constitute a self-capacitance touch sensor, plural detection electrode groups each including at least one detection electrode predetermined from the plurality of detection electrodes so as to correspond to the shape of the symbol, and a determination unit that is electrically connected to the plurality of detection electrodes and determines, when a sum of capacitances detected by the detection electrodes constituting one of the detection electrode groups is not less than a predetermined first threshold value, that a touch operation is performed on the symbol corresponding to the one detection electrode group.

### CROSS-REFERENCE TO RELATED APPLICATIONS

The present patent application claims the priority of Japanese patent application No. 2020/005096 filed on Jan. 16, 2020, and the entire contents of Japanese patent application No. 2020/005096 are hereby incorporated by reference.

### TECHNICAL FIELD

The present invention relates to an operation device.

### BACKGROUND ART

A switch device is known which is provided with electrodes having shapes corresponding to icons such as characters/letters or pictograms indicating functions, etc., of the switch (see, e.g., Patent Literature 1).

The electrodes are arranged on a back surface of a decorative panel provided on a right front passenger side door on the inner side of a vehicle and constitute a capacitive sensor.

### CITATION LIST

### Patent Literature

Patent Literature 1: JP 2006/321336 A

### SUMMARY OF INVENTION

In the known switch device, the electrodes have shapes corresponding to the icons. Therefore, when arranged on, e.g., a left front passenger side, not on a right front passenger side, the order of the icons is changed, which means that a common design cannot be used for the right front passenger side and the left front passenger side and it is not efficient in terms of designing.

It is an object of the invention to provide an operation device which can streamline the designing in the switch device.

According to an aspect of the invention, an operation device comprises:
an operation member comprising a plurality of symbols on a front surface side thereof;
a plurality of detection electrodes that are aligned on a back surface side of the operation member and constitute a self-capacitance touch sensor;
a plurality of detection electrode groups each comprising at least one detection electrode predetermined from the plurality of detection electrodes so as to correspond to the shape of the symbol; and
a determination unit that is electrically connected to the plurality of detection electrodes and determines, when a sum of capacitances detected by the detection electrodes constituting one of the detection electrode groups is not less than a predetermined first threshold value, that a touch operation is performed on the symbol corresponding to the one detection electrode group.

### Advantageous Effects of Invention

According to an embodiment of the invention, it is possible to streamline the designing in the switch device.

### BRIEF DESCRIPTION OF DRAWINGS

FIG. 1A is a diagram illustrating the inside of a vehicle in which an example of an operation device in the first embodiment is mounted.

FIG. 1B is an example block diagram illustrating the operation device.

FIG. 2A is a side view showing an example of an operating portion of the operation device in the first embodiment.

FIG. 2B is a diagram illustrating an example of plural symbols formed on an operation member.

FIG. 2C is an explanatory diagram illustrating an example of a relation between detection electrodes and the symbols in a right-hand drive vehicle.

FIG. 2D is an explanatory diagram illustrating an example of a relation between the detection electrodes and the symbols in a left-hand drive vehicle.

FIG. 3A is a diagram illustrating an example of a touch operation which is performed by a user on the operating portion of the operation device in the first embodiment.

FIG. 3B is a diagram illustrating an example of capacitance of each detection electrode.

FIG. 3C is a diagram illustrating an example of total capacitance of each detection electrode group.

FIG. 4 is a flowchart showing an example of an operation of the operation device in the first embodiment.

FIG. 5A is an example block diagram illustrating the operation device in the second embodiment.

FIG. 5B is a diagram illustrating an example of capacitance of each detection electrode.

FIG. 5C is a diagram illustrating an example of total capacitance of each detection electrode group.

FIG. 6 is a flowchart showing an example of an operation of the operation device in the second embodiment.

FIG. 7A is a diagram illustrating an example of plural symbols two-dimensionally arranged on the operation member of the operation device in the third embodiment.

FIG. 7B is an explanatory diagram illustrating an example of a relation between the detection electrodes and the symbols in a right-hand drive vehicle.

FIG. 7C is an explanatory diagram illustrating an example of a relation between the detection electrodes and the symbols in a left-hand drive vehicle.

### DESCRIPTION OF EMBODIMENTS

### Short Summary of the Embodiments

An operation device in the embodiments is generally provided with an operation member having plural symbols formed on a front surface side, plural detection electrodes that are aligned on a back surface side of the operation member and constitute a self-capacitance touch sensor, plural detection electrode groups each composed of at least one detection electrode pre-selected from the plural detection electrodes so as to correspond to the shape of the formed symbol, and a determination unit that is electrically connected to the plural detection electrodes and determines, when a sum of capacitances detected by the detection electrodes constituting a given detection electrode group is not less than a predetermined first threshold value, that an operation is performed on a symbol corresponding to the detection electrode group.

In this operation device, the detection electrode groups consisting of at least one detection electrode are pre-assigned to symbols so as to correspond to the shapes of the symbols. Therefore, even if the shapes of the symbols are changed, it is adaptable without changing the shapes of the detection electrode unlike when providing detection electrodes each corresponding to the shape of one symbol. The operation device thereby can streamline the designing.

### First Embodiment

(General Configuration of an Operation Device 1)

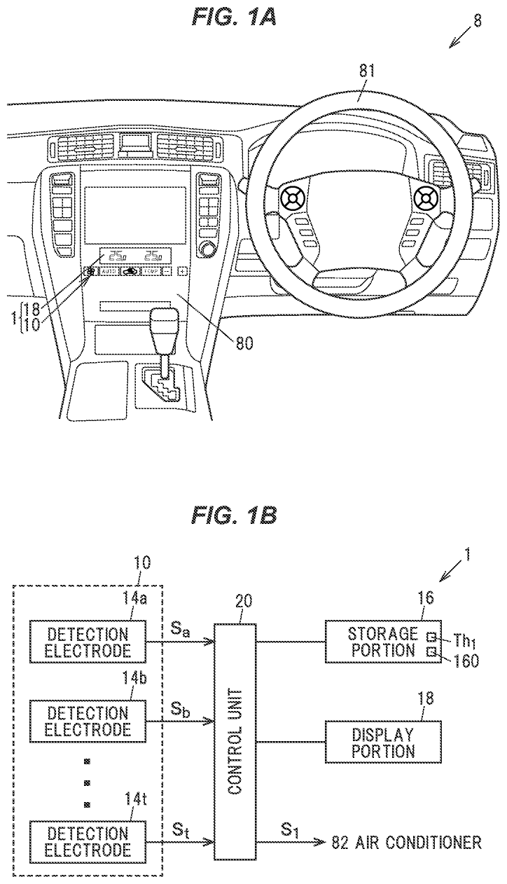

An example of the operation device in the first embodiment will be described below in reference to each drawing. In each drawing of the embodiment described below, a scale ratio may be different from an actual ratio. In addition, in FIG. 1B, flows of main signals and information are indicated by arrows.

FIG. 1A is a diagram illustrating the inside of a vehicle in which an example of the operation device is mounted and FIG. 1B is an example block diagram illustrating the operation device. As shown in FIG. 1A, an operation device 1 is arranged on a center console 80 of a vehicle 8. The operation device 1 is to operate an electronic device mounted on the vehicle 8. As an example, the electronic device is an air conditioner, a navigation device, a music and image reproduction device, or a vehicle control device for making the settings of the vehicle 8 or controlling the vehicle 8. The operation device 1 in the first embodiment controls an air conditioner 82 in response to an operation performed by a user, as an example.

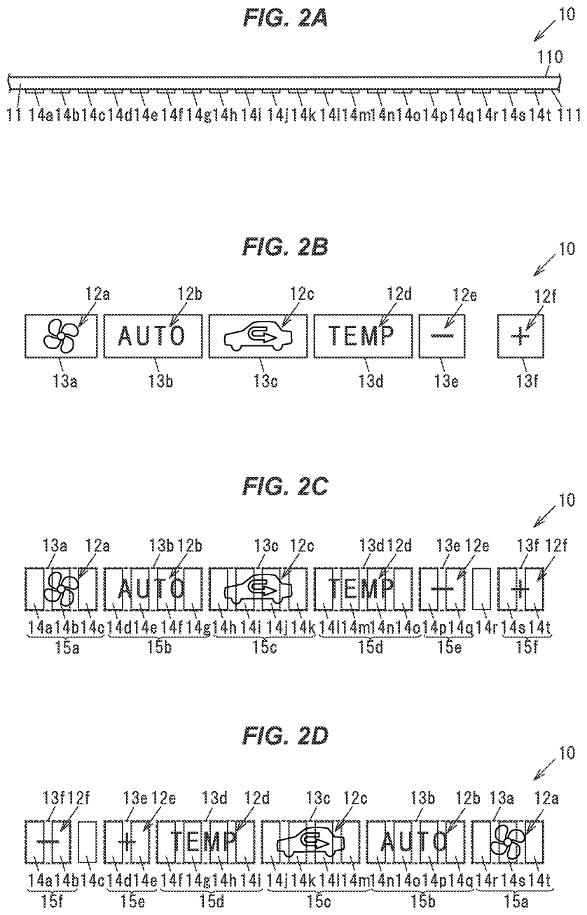

FIG. 2A is a side view showing an example of an operating portion of the operation device. As shown in FIGS. 1B and 2A, the operation device 1 is generally provided with an operation member 11 having plural symbols formed on a front surface 110 side, plural detection electrodes that are aligned on a back surface 111 side of the operation member 11 and constitute a self-capacitance touch sensor, plural detection electrode groups each composed of at least one detection electrode pre-selected from the plural detection electrodes so as to correspond to the shape of the formed symbol, and a control unit 20 as a determination unit that is electrically connected to the plural detection electrodes and determines, when a sum of capacitances detected by the detection electrodes constituting a given detection electrode group is not less than a predetermined first threshold value Th₁, that an operation is performed on a symbol corresponding to the detection electrode group.

FIG. 2B is a diagram illustrating an example of plural symbols formed on the operation member, and FIG. 2C is an explanatory diagram illustrating an example of a relation between the detection electrodes and the symbols in a right-hand drive vehicle.

As shown in FIG. 2B, the plural symbols are symbols 12a-12f, as an example. Meanwhile, as shown in FIG. 2A, the plural detection electrodes are detection electrodes 14a-14t, as an example. Then, as shown in FIG. 2C, the plural detection electrode groups are detection electrode groups 15a-15f, as an example.

The symbols 12a-12f are surrounded by frames 13a-13f so that boundaries of regions for accepting a touch operation on the symbol are recognizable. In addition, the symbols 12a-12f are fixed to the operation member 11. That is, the symbols 12a-12f and the frames 13a-13f are provided by printing, etc., on the front surface 110 of the operation member 11, as an example.

As shown in FIG. 1B, the operation device 1 is further provided with a storage portion 16 and a display portion 18. The storage portion 16 is a semiconductor memory provided on a substrate on which the control unit 20 is arranged, as an example. The storage portion 16 stores the first threshold value Th₁ and detection electrode group information 160. The display portion 18 is a liquid crystal monitor for displaying setting temperature, etc., of the air conditioner 82.

In the operation device 1, the operation member 11 and the detection electrodes 14a-14t constitute an operating portion 10, as shown in FIG. 2A. The operating portion 10 and the display portion 18 are arranged on the center console 80, as shown in FIG. 1A. The vehicle 8 in the first embodiment is a right-hand drive vehicle which has a steering wheel 81 on the right side. Therefore, the symbols 12a-12f are arranged so that it is easy to use for the user sitting in a driver's seat located on the right side.

(Configuration of the Operating Portion 10)

The operation member 11 is formed of a resin material such as polycarbonate and is formed in a plate shape. The front surface 110 of the operation member 11 may alternatively be a curved surface.

The detection electrodes 14a-14t are formed of a highly conductive metal such as silver. In addition, the detection electrodes 14a-14t have the same shape and are arranged side by side at equal intervals, as shown in FIG. 2C.

The width and intervals of the detection electrodes 14a-14t are set so that an operating finger is detected by plural detection electrodes. The width of the operating finger is different with each person but is roughly the same. Therefore, the detection electrodes are configured that the width of one individual detection electrode is smaller than the width of the operating finger and the operating finger when touching a portion between at least two detection electrodes is detected by both detection electrodes.

The detection electrodes 14a-14t are electrically connected to the control unit 20. The detection electrodes 14a-14t output capacitance signals Sₐ-Sₜ corresponding to capacitances, to the control unit 20. That is, each of the detection electrodes 14a-14t acts as a touch sensor which detects a touch operation.

The detection electrodes constitute the detection electrode groups which correspond to the shapes of the symbols. In the first embodiment, the detection electrode groups 15a-15f are pre-assigned to the symbols 12a-12f The information of the detection electrodes constituting the detection electrode groups 15a-15f is stored as the detection electrode group information 160 in the storage portion 16.

The symbol 12a represents that it is a touch switch with function of adjusting air volume of the air conditioner 82. The user can adjust the air volume by firstly performing a touch operation on the symbol 12a while using the frame 13a as a guide and then performing another touch operation on the symbol 12e (“−”, to reduce the air volume) or the symbol 12f (“+”, to increase the air volume). The touch operation on the symbol 12a is detected by the detection electrode group 15a which includes the detection electrodes 14a-14c.

The symbol 12b represents that it is a touch switch with function of turning on and off the AUTO mode of the air conditioner 82. By performing a touch operation on the symbol 12b while using the frame 13b as a guide, the user can activate the air conditioner 82 in the AUTO mode for automatically adjusting temperature or air volume, or can terminate the AUTO mode. The touch operation on the symbol 12b is detected by the detection electrode group 15b which includes the detection electrodes 14d-14g.

The symbol 12c represents that it is a touch switch with function of circulating the air in the vehicle 8. By performing a touch operation on the symbol 12c while using the frame 13c as a guide, the user can make the air in the vehicle 8 circulate or can draw in the external air without circulating. The touch operation on the symbol 12c is detected by the detection electrode group 15c which includes the detection electrodes 14h-14k.

The symbol 12d represents that it is a touch switch with function of adjusting the temperature setting of the air conditioner 82. The user can adjust the temperature setting by firstly performing a touch operation on the symbol 12d while using the frame 13d as a guide and then performing another touch operation on the symbol 12e (“−”, to lower the temperature) or the symbol 12f (“+”, to increase the temperature). The touch operation on the symbol 12d is detected by the detection electrode group 15d which includes the detection electrodes 14l-14o.

The symbol 12e represents that it is a touch switch with function of adjustment to turn down the air volume or temperature setting of the air conditioner 82. The touch operation on the symbol 12e is detected by the detection electrode group 15e which includes the detection electrodes 14p and 14q.

The symbol 12f represents that it is a touch switch with function of adjustment to turn up the air volume or temperature setting of the air conditioner 82. The touch operation on the symbol 12f is detected by the detection electrode group 15f which includes the detection electrodes 14s and 14t.

In the first embodiment, a detection electrode which is not used to constitute the detection electrode groups is included in the detection electrodes 14a-14t. As shown in FIGS. 2B and 2C, the symbol 12e and the symbol 12f are separated in such a manner that the detection electrode 14r is sandwiched therebetween. Thus, the detection electrode 14r is not used to detect a touch operation.

FIG. 2D is an explanatory diagram illustrating an example of a relation between the detection electrodes and the symbols in a left-hand drive vehicle. The driver's seat is located on the left side in the left-hand drive vehicle. Therefore, the order of the symbols 12a-12f is preferably reversed from that in the right-hand drive vehicle so that it is easy to use for the user sifting in the driver's seat on the left-hand side. Thus, the symbols 12a-12f are aligned from left to right on the plane of the paper of FIG. 2C in the right-hand drive vehicle but are aligned from right to left on the plane of the paper of FIG. 2D in the left-hand drive vehicle.

The operation device 1 detects a touch operation using detection electrode groups, not by detection electrodes each corresponding to the shape of one symbol. Therefore, even when the order of the symbols is changed as shown in FIGS. 2C and 2D, the operation device 1 can be flexibly adapted by changing the configuration of the detection electrode groups.

(Configuration of the Control Unit 20)

The control unit 20 is, e.g., a microcomputer composed of a CPU (Central Processing Unit) performing calculation and processing, etc., of the acquired data according to a stored program, and a RAM (Random Access Memory) and a ROM (Read Only Memory) as semiconductor memories, etc. The ROM stores, e.g., a program for operation of the control unit 20. The RAM is used as, e.g., a storage area for temporarily storing calculation results, etc. The control unit 20 also has, inside thereof, a means for generating a clock signal, and operates based on the clock signal. The storage portion 16 may be RAM or ROM of the control unit 20.

The control unit 20 selects detection electrodes from the detection electrodes 14a-14t based on the detection electrode group information 160 and configures the detection electrode groups 15a-15f The control unit 20 adds up capacitances detected by the detection electrodes constituting the detection electrode groups, compares the results to the first threshold value Th₁, and determines whether or not a touch operation is performed.

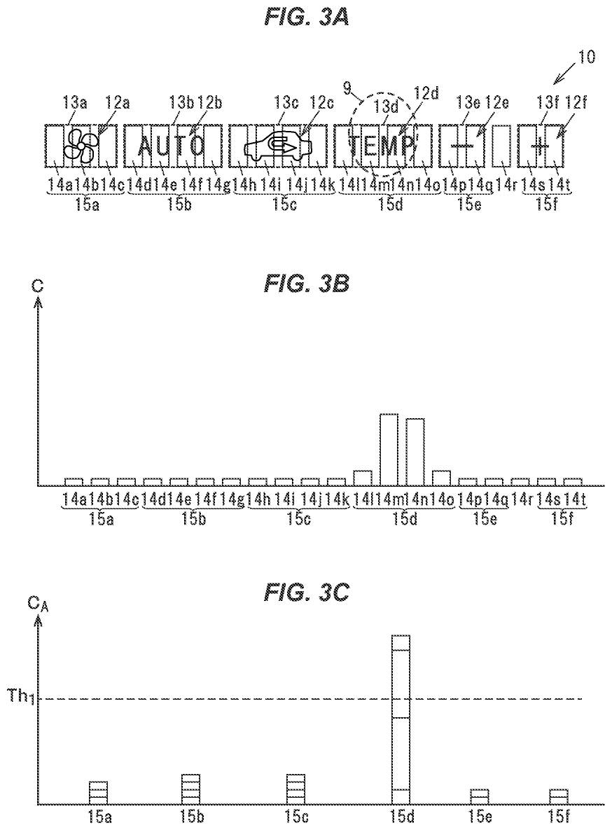

FIG. 3A is a diagram illustrating an example of the operating portion on which a touch operation is performed by the user, FIG. 3B is a diagram illustrating an example of capacitance of each detection electrode, and FIG. 3C is a diagram illustrating an example of total capacitance of each detection electrode group. In FIG. 3B, the horizontal axis shows detection electrodes and the vertical axis shows capacitance C. In FIG. 3C, the horizontal axis shows detection electrode groups and the vertical axis shows total capacitance C_{A}. The total capacitance C_{A} here is a sum of all capacitances detected by detection electrodes constituting a detection electrode group.

As shown in FIG. 3A, when the user performs a touch operation on the “TEMP” symbol 12d and the detection electrode group 15d detects an operating finger 9 indicated by a dashed line, capacitances detected mainly by the detection electrodes 14m and 14n increase as shown in FIG. 3B, as an example. FIG. 3B depicts that detection electrodes other than those constituting the detection electrode group 15d detect slight capacitance due to exogenous noise, etc.

The control unit 20 periodically acquires the capacitance signals Sₐ-Sₜ from the detection electrodes 14a-14t. Based on the detection electrode group information 160, the control unit 20 adds up capacitances indicated by the capacitance signals Sₐ-Sₜ for each of the detection electrode groups 15a-15f.

Since the total capacitance C_{A} of the detection electrode group 15d which detected the operating finger 9 is more than the first threshold value Th₁ as shown in FIG. 3C, the control unit 20 determines that a touch operation is performed on the detection electrode group 15d. Then, based on the determination result, the control unit 20 outputs operation information S₁, which indicates that a touch operation is performed on the detection electrode group 15d, to the connected air conditioner 82.

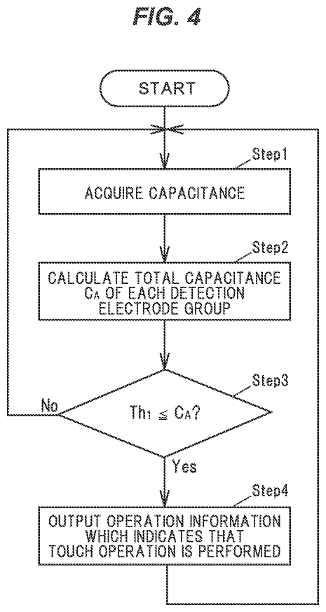

Next, an operation of the operation device 1 in the first embodiment will be described along with the flowchart in FIG. 4.

(Operation)

The control unit 20 of the operation device 1 acquires the capacitance signals Sₐ-Sₜ from the detection electrodes 14a-14t and reads the capacitances C (Step 1). Based on the detection electrode group information 160 acquired from the storage portion 16, the control unit 20 calculates the total capacitance C_{A} of each detection electrode group (Step 2).

The control unit 20 compares the calculated total capacitances C_{A} to the first threshold value Th₁ acquired from the storage portion 16. Then, when there is total capacitance C_{A} which is not less than the first threshold value Th₁ (=Th₁≤C_{A}) (Step 3: Yes), the control unit 20 determines that a touch operation is performed.

The control unit 20 generates the operation information S₁ including information of the detection electrode group detected the touch operation and outputs the operation information S₁ to the air conditioner 82 (Step 4), and then proceeds the process to Step 1 to read capacitances in the next cycle. This operation is continuously performed until the operation device 1 is turned off.

Meanwhile, when there is no detection electrode group which detected a touch operation in Step 3 (Step 3: No), the control unit 20 proceeds the process to Step 1 to read capacitances in the next cycle.

### Effects of the First Embodiment

The operation device 1 in the first embodiment can streamline the designing. In particular, in the operation device 1, the detection electrode groups 15a-15f are pre-assigned to the symbols 12a-12f so as to correspond to the shapes of the symbols 12a-12f. Therefore, even if the shapes of the symbols are changed, it is adaptable without changing the shapes of the detection electrodes unlike when providing detection electrodes each corresponding to the shape of one symbol. The operation device 1 thereby can streamline the designing.

Vehicles, even of the same model, are sometimes manufactured as right-hand drive and left-hand drive depending on which countries the vehicles are marketed. The operation device 1 can be adapted to the change of the order of the symbols or to a different symbol arrangement, etc., by changing the configuration of the detection electrode groups, no matter which side the steering wheel is on. Therefore, unlike when such a configuration is not adopted, it is not necessary to redesign the arrangement, etc., of the detection electrodes and it is possible to design efficiently.

In case that the front surface 110 of the operation member 11 is a flat surface, users often recognize the touch switch area based on symbols such as characters/letters or shapes indicating functions of the touch switch. Then, if each detection electrode is provided so as to correspond to one symbol, every touch switch needs to be designed differently, and in addition to this, it is necessary to newly design when the size or number of the characters/letters of the symbol is changed or the shapes are changed, hence, it is inefficient. In contrast, the operation device 1 only requires changing the configuration of the detection electrodes so as to correspond to the symbols as described above and thus can streamline the designing.

### Second Embodiment

The second embodiment is different from other embodiments in that two threshold values are provided.

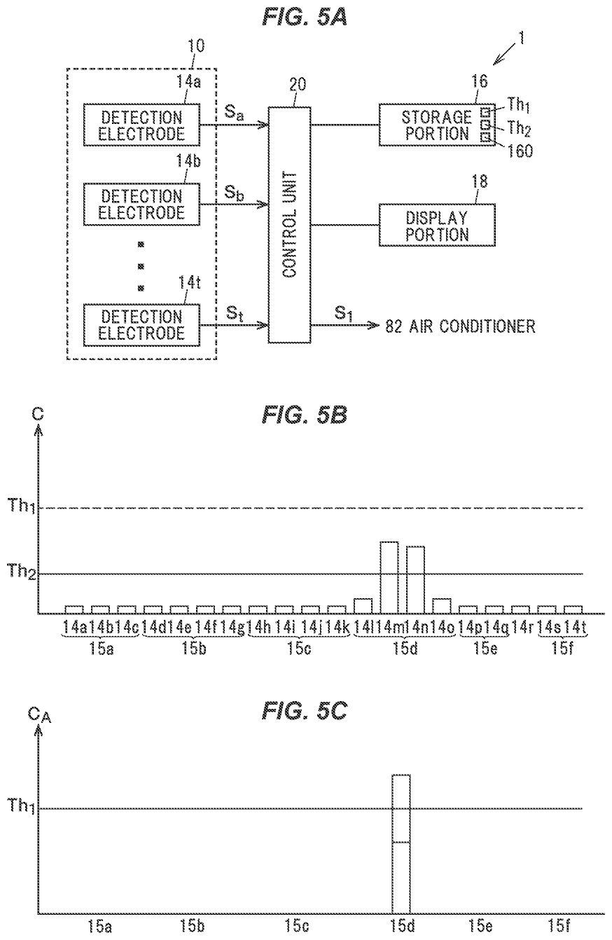

FIG. 5A is an example block diagram illustrating the operation device, FIG. 5B is a diagram illustrating an example of capacitance of each detection electrode, and FIG. 5C is a diagram illustrating an example of total capacitance of each detection electrode group. In FIG. 5B, the horizontal axis shows the detection electrodes and the vertical axis shows the capacitance C. In FIG. 5C, the horizontal axis shows the detection electrode groups and the vertical axis shows the total capacitance C_{A}. In addition, the capacitances C and the total capacitances C_{A} shown in FIGS. 5B and 5C are obtained when a touch operation is performed on the detection electrode group 15d in the same manner as shown in FIG. 3A of the first embodiment. For the purpose of comparison, the first threshold value Th₁ is indicated by a dashed line in FIG. 5B.

In the embodiments described below, portions having the same functions and configurations as those in the first embodiment will be denoted by the same reference numerals as those in the first embodiment and the explanation therefor will be omitted.

As shown in FIGS. 5A to 5C, the control unit 20 has a second threshold value Th₂ smaller than the first threshold value Th₁ and calculates the sum of the capacitances C of not less than the second threshold value Th₂ (=the total capacitance C_{A}) for each of the plural detection electrode groups. The second threshold value Th₂ is stored in the storage portion 16 but it is not limited thereto. The second threshold value Th₂ may be stored in the RAM or ROM of the control unit 20.

The second threshold value Th₂ is a threshold for capacitance detected due to exogenous noise, etc. Since the control unit 20 calculates the total capacitance C_{A} of the detection electrode group including the detection electrodes which detected the capacitances of not less than the second threshold value Th₂, processing is faster than when the total capacitances C_{A} of all detection electrode groups are calculated. Therefore, as shown in FIG. 5C, the control unit 20 calculates the total capacitance C_{A} of only the detection electrode group 15d where the capacitances C of not less than the second threshold value Th₂ are detected.

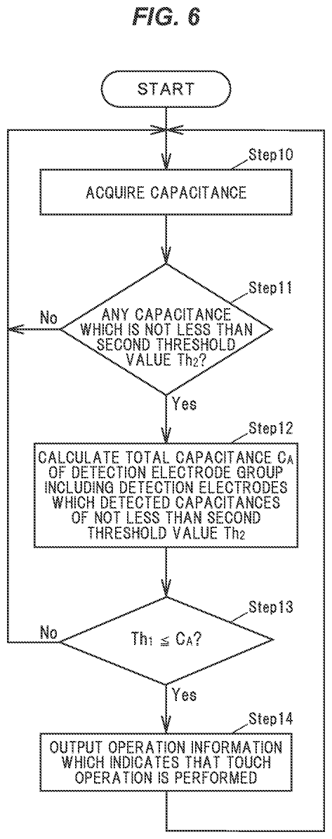

Next, an example of an operation of the operation device 1 in the second embodiment will be described along with the flowchart in FIG. 6.

(Operation)

The control unit 20 of the operation device 1 acquires the capacitance signals Sₐ-Sₜ from the detection electrodes 14a-14t and reads the capacitances C (Step 10). The control unit 20 compares the read capacitances C to the second threshold value Th₂ acquired from the storage portion 16.

When the capacitances C of not less than the second threshold value Th₂ are detected (Step 11: Yes), the control unit 20 calculates the total capacitance C_{A} for each of the detection electrode groups including the detection electrodes which detected the capacitances C of not less than the second threshold value Th₂ (Step 12).

The control unit 20 compares the calculated total capacitance C_{A} to the first threshold value Th₁ acquired from the storage portion 16. When there is the total capacitance C_{A} which is not less than the first threshold value Th₁ (=Th₁≤C_{A}) (Step 13: Yes), the control unit 20 determines that a touch operation is performed.

The control unit 20 generates the operation information S₁ including information of the detection electrode group detected the touch operation and outputs the operation information S₁ to the air conditioner 82 (Step 14), and then proceeds the process to Step 1 to read capacitances in the next cycle. This operation is continuously performed until the operation device 1 is turned off.

Meanwhile, when capacitances C of not less than the second threshold value Th₂ are not detected in Step 11 (Step 11: No), the control unit 20 proceeds the process to Step 10. Then, when there is no detection electrode group with the total capacitance C_{A} of not less than the first threshold value Th₁ in Step 13 (Step 13: No), the control unit 20 proceeds the process to Step 10 to read capacitances in the next cycle.

### Effects of the Second Embodiment

The operation device 1 in the second embodiment calculates the total capacitance C_{A} for not all the detection electrode groups but for the detection electrode group including the detection electrodes which detected the capacitances C of not less than the second threshold value Th₂. Therefore, the operation device 1 can efficiently determine a touch operation and can perform the processing faster.

### Third Embodiment

The third embodiment is different from the other embodiments in that detection electrodes are arranged two-dimensionally.

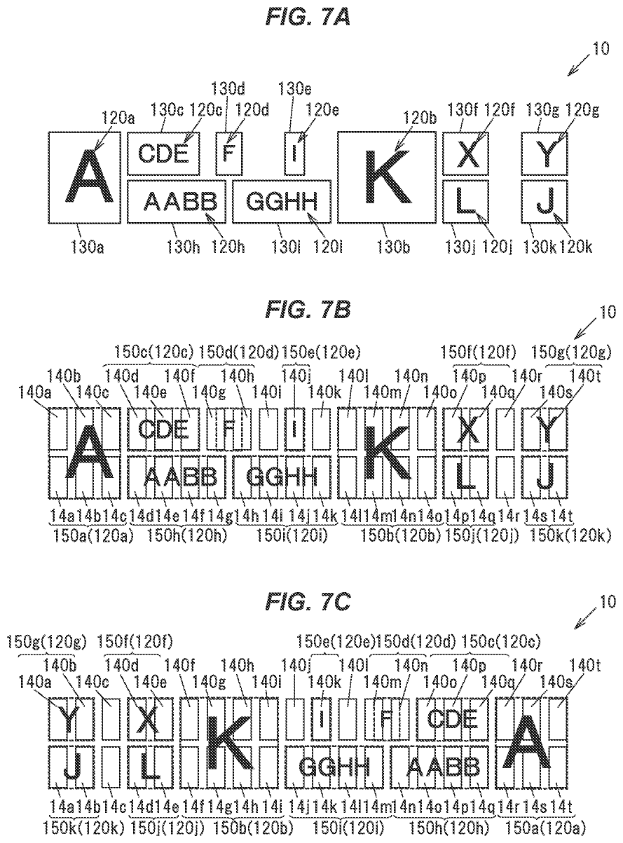

FIG. 7A is a diagram illustrating an example of the plural symbols two-dimensionally arranged on the operation member, and FIG. 7B is an explanatory diagram illustrating an example of a relation between the detection electrodes and the symbols in a right-hand drive vehicle. In FIG. 7B and FIG. 7C (described later), symbols 120a-120k shown in FIG. 7A are denoted next to detection electrode groups 150a-150k. In addition, in FIGS. 7B and 7C, frames 130a-130k are indicated by dashed lines.

As shown in FIG. 7A, the symbols 120a-120k having various sizes and shapes are provided on the operation device 1 in the third embodiment. The symbols 120a-120k are surrounded by the frames 130a-130k so that boundaries of regions for accepting a touch operation on the symbol are recognizable.

In the operation device 1, the detection electrodes 14a-14t are arranged in a lower row as viewed in FIGS. 7B and 7C and detection electrodes 140a-140t are arranged in an upper row. The detection electrodes 14a-14t and the detection electrodes 140a-140t have the same shape and are arranged at equal intervals as an example, but it is not limited thereto.

The symbols 120a and 120b have shapes extending across the upper and lower rows. A touch operation on the symbol 120a is detected by the detection electrode group 150a which includes the detection electrodes 14a-14c and the detection electrodes 140a-140c. Meanwhile, a touch operation on the symbol 120b is detected by the detection electrode group 150b which includes the detection electrodes 14l-14o and the detection electrodes 140l-140o.

The symbols 120c-120g have shapes extending across some of the detection electrodes in the upper row. A touch operation on the symbol 120c is detected by the detection electrode group 150c which includes the detection electrodes 140d-140f. A touch operation on the symbol 120d is detected by the detection electrode group 150d which includes the detection electrodes 140g and 140h. A touch operation on the symbol 120e is detected by the detection electrode group 150e which includes the detection electrode 140j. A touch operation on the symbol 120f is detected by the detection electrode group 150f which includes the detection electrodes 140p and 140q. A touch operation on the symbol 120g is detected by the detection electrode group 150g which includes the detection electrodes 140s and 140t.

The symbols 120h-120k have shapes extending across some of the detection electrodes in the lower row. A touch operation on the symbol 120h is detected by the detection electrode group 150h which includes the detection electrodes 14d-14g. A touch operation on the symbol 120i is detected by the detection electrode group 150i which includes the detection electrodes 14h-140k. A touch operation on the symbol 120j is detected by the detection electrode group 150j which includes the detection electrodes 14p and 14q. A touch operation on the symbol 120k is detected by the detection electrode group 150k which includes the detection electrodes 14s and 14t.

The detection electrodes 14r, 140i, 140k and 140r are detection electrodes which are not used to constitute any detection electrode group.

Meanwhile, the symbol 120d is a symbol which includes a portion of the detection electrode 140g and a portion of the detection electrode 140h, as shown in FIG. 7B. Since the shape of the operating finger does not change, the operation device 1 can determine whether or not a touch operation is performed based on the total capacitance C_{A} obtained by adding up the capacitances C detected by the detection electrode 140g and the detection electrode 140h of the detection electrode group 150d.

Furthermore, with the symbol 120e, the detection electrode group 150e consists of one detection electrode (=the detection electrode 140j). The operation device 1 uses the capacitance C detected by the detection electrode 140j as the total capacitance C_{A} and determines whether or not a touch operation is performed.

FIG. 7C is an explanatory diagram illustrating an example of a relation between the detection electrodes and the symbols in a left-hand drive vehicle. The driver's seat is located on the left side in the left-hand drive vehicle. Therefore, the symbols 120a-120k are aligned from left to right on the plane of the paper of FIG. 7B in the right-hand drive vehicle but are aligned from right to left on the plane of the paper of FIG. 7C in the left-hand drive vehicle.

Thus, the configuration of the detection electrode groups 150a-150k is different between FIG. 7B and FIG. 7C. The detection electrode group 150a corresponding to the symbol 120a in the right-hand drive vehicle is composed of the detection electrodes 14a-14c and the detection electrodes 140a-140c. On the other hand, the detection electrode group 150a corresponding to the symbol 120a in the left-hand drive vehicle is composed of the detection electrodes 14r-14t and the detection electrodes 140r-140t. Since the control unit 20 changes the configuration of the detection electrode groups 150a-150k based on the detection electrode group information 160, it is possible to flexibly adapt to the change in design.

The operation device 1 detects a touch operation using detection electrode groups, not by detection electrodes each corresponding to the shape of one symbol. Therefore, even when the order of the symbols is changed as shown in FIGS. 7B and 7C, the operation device 1 can be flexibly adapted by changing the configuration of the detection electrode groups.

### Effects of the Third Embodiment

The operation device 1 in the third embodiment does not require changing the size or arrangement of the detection electrodes even when the symbols are arranged two-dimensionally. Therefore, it is possible to flexibly adapt to change in design.

The operation device 1 in at least one of the above-described embodiments streamline the designing.

Some portions of the operation device 1 in the embodiments and modifications may be realized by, e.g., a computer executable program, ASIC (Application Specific Integrated Circuit) and FPGA (Field-Programmable Gate Array), etc., according to the intended use.

Although some embodiments of the invention have been described, these embodiments are merely examples and the invention according to claims is not to be limited thereto. These new embodiments may be implemented in various other forms, and various omissions, substitutions and changes, etc., can be made without departing from the gist of the invention. In addition, all combinations of the features described in these embodiments are not necessary to solve the problem of the invention. Further, these embodiments are included within the scope and gist of the invention and also within the invention described in the claims and the range of equivalency.

### REFERENCE SIGNS LIST

1 OPERATION DEVICE
8 VEHICLE
9 OPERATING FINGER
10 OPERATING PORTION
11 OPERATION MEMBER
12a-12f SYMBOL
13a-13f FRAME
14a-14t DETECTION ELECTRODE
15a-15f DETECTION ELECTRODE GROUP
16 STORAGE PORTION
18 DISPLAY PORTION
20 CONTROL UNIT
80 CENTER CONSOLE
81 STEERING WHEEL
82 AIR CONDITIONER
110 FRONT SURFACE
111 BACK SURFACE
120a-120f SYMBOL
130a-130f FRAME
140a-140t DETECTION ELECTRODE
150a-150f DETECTION ELECTRODE GROUP
160 DETECTION ELECTRODE GROUP INFORMATION

1. An operation device, comprising:
an operation member comprising a plurality of symbols on a front surface side thereof;
a plurality of detection electrodes that are aligned on a back surface side of the operation member and constitute a self-capacitance touch sensor;
a plurality of detection electrode groups each comprising at least one detection electrode predetermined from the plurality of detection electrodes so as to correspond to the shape of the symbol; and
a determination unit that is electrically connected to the plurality of detection electrodes and determines, when a sum of capacitances detected by the detection electrodes constituting one of the detection electrode groups is not less than a predetermined first threshold value, that a touch operation is performed on the symbol corresponding to the one detection electrode group.

2. The operation device according to claim 1, wherein the plurality of detection electrodes comprise a detection electrode that is not used to constitute any detection electrode group.

3. The operation device according to claim 1, wherein the determination unit comprises a second threshold value smaller than the first threshold value, calculates a sum of capacitances of not less than the second threshold value in one of the detection electrode groups, and determines, when the sum of capacitances is not less than the first threshold value, that the touch operation is performed on the symbol corresponding to the one detection electrode group.

4. The operation device according to claim 1, wherein the plurality of symbols are fixed to the operation member.

5. The operation device according to claim 1, wherein the plurality of detection electrodes have the same shape and are aligned at equal intervals.

6. An operation device, comprising:
an operation member comprising a symbol formed on a front surface side thereof;
a plurality of detection electrodes that are aligned on a back surface side of the operation member and constitute a self-capacitance touch sensor;
a detection electrode group comprising the plurality of detection electrodes so as to correspond to the shape of the symbol; and
a determination unit that is electrically connected to the plurality of detection electrodes and determines, when a sum of capacitances detected by the detection electrodes constituting the detection electrode group is not less than a predetermined first threshold value, that a touch operation is performed on the symbol corresponding to the detection electrode group.

7. The operation device according to claim 1, wherein the plurality of detection electrodes comprise a detection electrode that is not used to constitute any detection electrode group.

8. The operation device according to claim 1, wherein the determination unit comprises a second threshold value smaller than the first threshold value, calculates a sum of capacitances of not less than the second threshold value in the detection electrode group, and determines, when the sum of capacitances is not less than the first threshold value, that the touch operation is performed on the symbol corresponding to the detection electrode group.
